(19) United States
(12) Patent Application Publication
(10) Pub. No.: US 2018/0213111 A1
(43) Pub. Date: Jul. 26, 2018

(54) PRINT PROCESSING SYSTEM, SERVER, AND PRINT APPARATUS

(71) Applicant: SEIKO EPSON CORPORATION, Tokyo (JP)

(72) Inventors: Masahiko HIRASAWA, Yamagata-mura (JP); Hiroshi IEZAKI, Matsumoto-shi (JP); Nobuhiro TSUJIOKA, Matsumoto-shi (JP); Tatsuro OSHIKAWA, Shiojiri-shi (JP)

(21) Appl. No.: 15/868,360

(22) Filed: Jan. 11, 2018

(30) Foreign Application Priority Data
Jan. 20, 2017 (JP) 2017-008169

(51) Int. Cl. H04N 1/32; H04N 1/00; G06F 3/12

(52) U.S. Cl. CPC H04N 1/32122; H04N 1/00344; G06F 3/1231; H04N 2201/3246; H04N 2201/3207; H04N 2201/3205; G06F 3/1226

(57) ABSTRACT

A print processing system includes a server that includes a first storage that stores image processing information required to generate print data for each of print media and a print apparatus that executes printing based on the print data. The print apparatus includes a second storage that stores address information of the image processing information in the first storage in association with the print media and a transfer processor that is configured to transfer a request to the server with reference to the address information stored in the second storage. In a case of receiving the request, the server reads the image processing information from the first storage based on the referred address information and transmits the read image processing information to the image processing apparatus.

### CROSS-REFERENCE TO RELATED APPLICATIONS

The present application claims priority to Japanese Patent Application No. 2017-008169, filed Jan. 20, 2017, which is hereby incorporated by reference in its entirety.

### BACKGROUND

### 1. Technical Field

The present invention relates to a print processing system, and a server and a print apparatus as a part of the system.

### 2. Related Art

In some cases, a print processing system for performing printing on print media is configured to have different apparatuses of a print apparatus (printer) that performs print processing on the print media and an image processing apparatus that performs generation processing of print data to be printed by a printer from each other. For example, in general, the print data is generated by a computer corresponding to the image processing apparatus, and the printer receives the generated print data from the computer and executes the print processing. In so-called large format printer (LFP) field, in particular, such system is widely employed.

A printer driver program that generates print data for forming an image corresponding to the orientation and type of print paper which is set in a paper feeding apparatus set as the paper feeding apparatus used for printing is disclosed (refer to JP-A-2010-102398).

In the system described above, print media to be targeted is required to match in the image processing apparatus and the print apparatus in order to complete the printing and obtain a printed object with high quality. For this, the image processing apparatus generating the print data needs to acquire information (image processing information) necessary for generating the print data suitable for the print media used by the print apparatus. However, since such image processing information has a large amount of information, it is not always possible for the print apparatus to hold the image processing information. In such circumstance, there is a need for the image processing apparatus to appropriately obtain the image processing information used for generating the print data.

### SUMMARY

An advantage of some aspects of the invention is that it provides a print processing system, a server, and a print apparatus capable of appropriately acquiring image processing information by an apparatus requiring the image processing information.

According to an aspect of the invention, there is provided a print processing system including a server that includes a first storage that stores image processing information required to generate print data for each of print media and a print apparatus that executes printing based on the print data. The print apparatus includes a second storage that stores address information of the image processing information stored in the first storage and a transfer processor that is configured to transfer a request to the server with reference to the address information stored in the second storage corresponding to a designated print medium in a case where the request of the image processing information corresponding to the designated print medium is received from an image processing apparatus generating the print data. In a case of receiving the request, the server reads the image processing information from the first storage based on the referred address information and transmits the read image processing information to the image processing apparatus.

In this configuration, the print apparatus stores the address information of the image processing information in the first storage (server) instead of the image processing information in the second storage. Thereby, when the request of the image processing information is received from the image processing apparatus, the print apparatus transmits the image processing information from the first storage (server) to the image processing apparatus with reference to the address information. Accordingly, even when the print apparatus does not store the image processing information, it is possible for the image processing apparatus to acquire the image processing information required by the image processing apparatus.

In the system, the server may store medium print information which is information associating the image processing information with print setting information required for printing on each of print media in the first storage, and the print apparatus may include a storage processor that is configured to acquire the print setting information and address information from the first storage and store the acquired pieces of information in the second storage in association with the print media.

In this configuration, the print apparatus acquires the print setting information and the address information from the server and stores the acquired pieces of information in the second storage. Thereby, it is possible for the print apparatus to execute the printing based on the print data generated by the image processing apparatus in setting according to the print setting information stored in the second storage.

In the system, the server may switch which of the image processing information stored in the first storage and address information of the image processing information in the first storage is to be transmitted to the print apparatus based on model information of the print apparatus acquired from the print apparatus.

In this configuration, it is possible for the server to appropriately determine which of the image processing information and the address information of the image processing information in the first storage is stored in the print apparatus according to capability of the print apparatus indicated by model information of the print apparatus.

In the system, the storage processor may store any one of the print setting information and the image processing information or the print setting information and the address information transmitted from the server in the second storage.

In this configuration, it is possible for the print apparatus to store any one of a set of the print setting information and the image processing information or a set of the print setting information and the address information selected by the server according to capability of the apparatus indicated by model information of the apparatus.

In the system, the server may transmit the print setting information and the image processing information to the print apparatus in a case where the model information indicates that a model has storage capacity equal to or larger than a predetermined capacity, and may transmit the print setting information and the address information to the print apparatus in a case where the model information does not indicate that a model has storage capacity equal to or larger than the predetermined capacity.

In this configuration, it is possible for the server to appropriately determine which of the image processing information and the address information of the image processing information in the first storage is stored in the print apparatus according to storage capacity of the print apparatus.

The technical idea of the invention can be realized in various modes other than a category of the print processing system. The server, the print apparatus, and further the image processing apparatus included in the print processing system are established respectively as an invention. An invention of each method corresponding to steps executed by each of the server, the print apparatus, and the image processing apparatus, an invention of each program for causing hardware (computer) such as the server, the print apparatus, and the image processing apparatus to execute the steps, and an invention of a computer-readable storage medium that stores each program are established respectively.

According to another aspect of the invention, there is provided a server that communicates with a print apparatus, the server including a storage that stores image processing information required to generate print data for each of print media and a communication processor that is configured to control the communication. The communication processor can grasp a configuration of switching which of the image processing information stored in the storage and address information of the image processing information in the storage is to be transmitted to the print apparatus based on model information of the print apparatus acquired from the print apparatus.

In the server, the communication processor may transmit the image processing information to the print apparatus in a case where the model information indicates that a model has storage capacity equal to or larger than a predetermined capacity, and transmit the address information to the print apparatus in a case where the model information does not indicate that a model has storage capacity equal to or larger than the predetermined capacity.

According to still another aspect of the invention, there is provided a print apparatus including a storage that stores address information of image processing information required to generate print data for each of print media and a transfer processor that is configured to transfer a request to a server to acquire image processing information from the server with reference to the address information stored in the storage corresponding to a designated print medium in a case where the request of the image processing information corresponding to the designated print medium is received from an image processing apparatus generating the print data.

### BRIEF DESCRIPTION OF THE DRAWINGS

The invention will be described with reference to the accompanying drawings, wherein like numbers reference like elements.

FIG. 1 is a diagram showing a configuration of a print processing system in a simplified manner.

FIG. 2A is a diagram showing a configuration of a media table, and FIG. 2B is a diagram showing a configuration of a media table having address information instead of image processing information.

FIG. 3 is a diagram showing a structure of the image processing information.

FIG. 4 is a diagram showing a download screen.

FIG. 5 is a flowchart showing download switching processing by a media server.

FIG. 6 is a diagram showing a media registration list.

FIG. 7 is a diagram showing an editing screen.

FIG. 8 is a flowchart showing print data generation processing by an image processing apparatus.

FIG. 9 is a flowchart showing processing executed in a case where a printer having the address information of the image processing information receives a request of the image processing information.

FIG. 10 is a flowchart showing print processing by the printer.

### DESCRIPTION OF EXEMPLARY EMBODIMENTS

Hereinafter, embodiments of the invention will be described with reference to drawings. Each drawing is only an example for describing the embodiments.

### 1. Outline Description of System

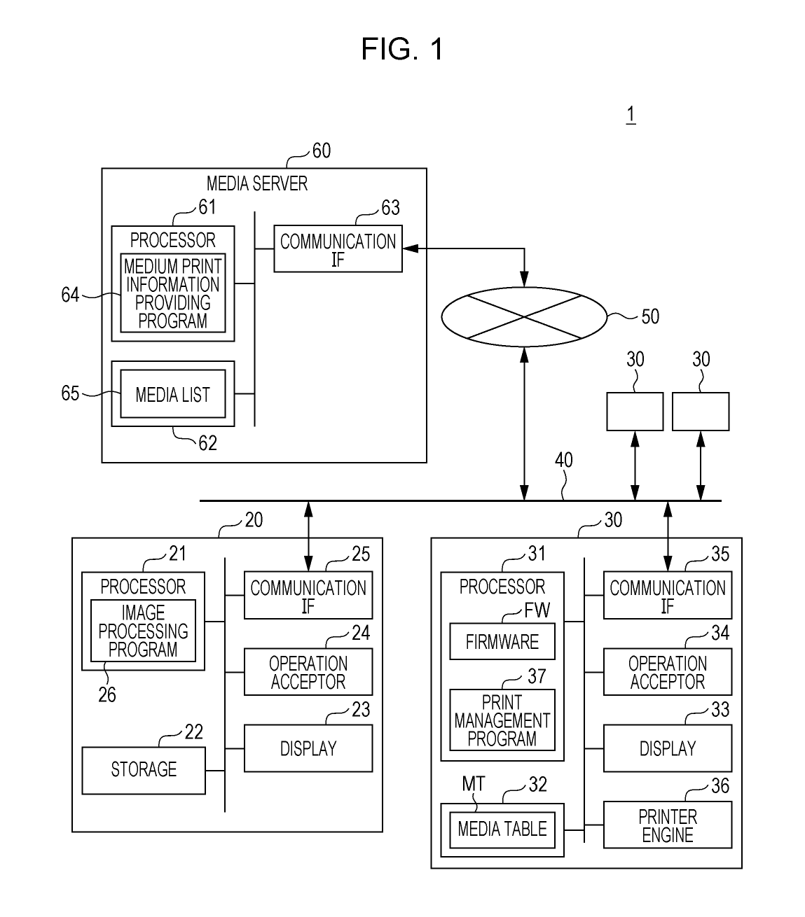

FIG. 1 shows a configuration of a print processing system (hereinafter, system) 1 according to an embodiment in a simplified manner. The system 1 may be referred to as a print management system or the like. The system 1 includes a part or all of an image processing apparatus 20, a printer 30, and a media server 60.

The image processing apparatus 20 and the printer 30 are connected to, for example, a wired or wireless local area network (LAN) 40 and can communicate with each other. Specifically, various apparatuses such as the image processing apparatus 20 and the printer 30 are connected to the LAN 40 connected to an internet communication network 50 which is a public communication line through a router (not shown). A plurality of such various apparatuses may be included in the system 1. In the embodiment, in particular, it is assumed that a plurality of printers 30 is included in the system 1.

Here, the connection of the image processing apparatus 20 and the printer 30 to a common LAN is not an essential configuration as long as the apparatus and the printer can communicate with each other. For example, the printer 30 connects to the internet communication network 50 while existing outside the LAN 40. In the case, the printer 30 functions as a printer supporting so-called cloud print capable of accepting a print instruction from each terminal such as the image processing apparatus 20 connectable to the internet communication network 50.

The internet communication network 50 is connected to at least one media server 60 that holds and releases various kinds of information, such as firmware FW of the printer 30 or a media file MF described below, necessary for operating the system 1. The media server 60 is realized as a part (virtual server) of the cloud environment for supplying a cloud service through the internet communication network 50 or is realized by a physical server.

The image processing apparatus 20 are realized by, for example, the personal computer (PC) or an information terminal having the same processing function as the PC. The image processing apparatus 20 includes a processor 21, a storage 22, a display 23, an operation acceptor 24, a communication interface (IF) 25, and the like. The processor 21 is configured to have, for example, an IC having a CPU, a ROM, a RAM, and the like and another memory. In the processor 21, the CPU executes calculation processing according to a program using the RAM or the like as a work area to control an operation of the image processing apparatus 20. As a type of such program, the processor 21 mounts a print processing program 26. The image processing program 26 also functions as raster image processor (RIP) software which is dedicated to generating raster data (print data) subjected to bitmap expansion for each color (for example, cyan (C), magenta (M), yellow (Y), and black (K)) used by the printer 30 for printing. Accordingly, the image processing program 26 may be referred to as the RIP software, and the image processing apparatus 20 that mounts the image processing program 26 may be referred to as a RIP apparatus.

An RIP is used to obtain a relatively high quality printed object. For example, print data is generated by the RIP for executing printing using a high quality and large-sized printer (LFP) for business use used in a print company. The storage 22 is configured to have a storage medium such as a hard disk drive (HDD) or a flash memory. The storage 22 may be a part of the processor 21. A communication IF 25 is a general term for an IF corresponding to a predetermined communication standard for communicating with the outside.

The display 23 is a unit for displaying visual information and is configured to have, for example, a liquid crystal display (LCD) or an organic EL display. The display 23 may be configured to have a display and a driving circuit for driving the display. The operation acceptor 24 is a unit for accepting an operation by a user and is realized by, for example, a physical button, a touch panel, a mouse, or a keyboard. Needless to say, the touch panel may be realized as one function of the display 23.

The printer 30 has a general configuration as a network printer and includes a processor 31, a storage 32, a display 33, an operation acceptor 34, a communication IF 35, a printer engine 36, and the like. The processor 31 is configured to have, for example, an IC having a CPU, a ROM, a RAM, and the like and another memory. In the processor 31, the CPU executes calculation processing according to firmware FW using the RAM or the like as a work area to control an operation of the printer 30. The processor 31 mounts a print management program 37 for causing the printer 30 to execute processing relating to print management as a type of such program. The print management program 37 may be a type of an extension function of the firmware FW. Alternately, the print management program 37 and the firmware FW are may collectively be referred to as a print management program. Above description of the storage 22, the display 23, the operation acceptor 24, and the communication IF 25 can be applied mutatis mutandis to the basic description of the storage 32, the display 33, the operation acceptor 34, and the communication IF 35. It can be referred to as an operation panel or the like of the printer 30 including the display 33 and the operation acceptor 34.

The printer engine 36 is a mechanism that executes a print operation on print media under the control of the processor 31. The print media is not limited to paper, but refers to a medium made of various materials, such as a film or a fiber, to which ink or toner is adhered. The printer engine 36 is, for example, a mechanism that performs printing by ejecting liquid such as ink by an ink jet method. The printer engine 36 includes a print head for ejecting liquid such as ink, a carriage for moving the print head in a constant scanning direction, a transport mechanism for transporting the print media, a heater for drying the print media, and the like. A print method of the printer engine 36 is not limited to the ink jet type, but various methods such as an electrophotographic method can be employed.

The media server 60 includes a processor 61, a storage 62, a communication IF 63, and the like. The processor 61 is configured to have, for example, an IC having a CPU, a ROM, a RAM, and the like and another memory. In the processor 61, the CPU executes calculation processing according to firmware FW using the RAM or the like as a work area to control an operation of the media server 60. The processor 61 mounts a medium print information providing program 64 as a type of such program. Above description of the storage 22 and the communication IF 25 can be applied mutatis mutandis to the basic description of the storage 62 and the communication IF 63. The storage 62 corresponds to an example of a medium print information storage (first storage) that stores medium print information, and the storage 32 of the printer 30 corresponds to a second storage. The processor 61 and the communication IF 63 cooperate to function as a communication processor that is configured to for controlling the communication with the outside including the printer 30.

The system 1 is a system that the image processing apparatus 20 generates print data from an image designated by the user, and the printer 30 executes printing to a designated print medium based on the print data. There are various images to be printed such as a text image created by document creation software, a graphic image formed by drawing software, a photo captured by a digital camera, or an image scanned by a scanner.

### 2. Description of Media Table MT

Next, a media table MT will be described. As shown in FIG. 1, the printer 30 stores the media table MT in the storage 32. In the media table MT, information required by each of the image processing apparatus 20 and the printer 30 is described in order to realize printing on print media.

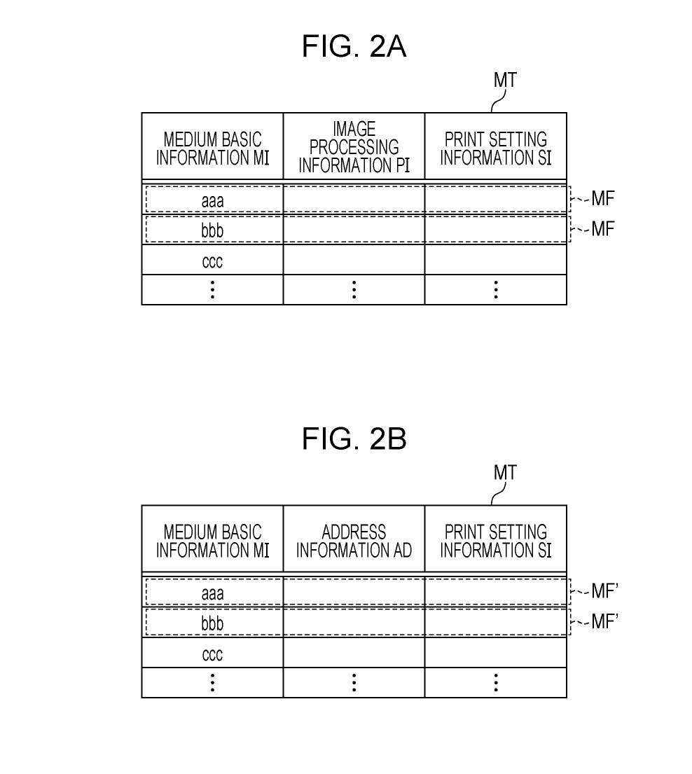

FIG. 2A exemplifies a configuration of the media table MT. The media table MT is an information group of each printer 30 included in the system 1, and the media table MT shown in FIG. 2A is a collection of the media files MF. As shown in FIG. 2A, in the media table MT of one printer 30, there is stored a media file MF for each of print media indicated by symbols “aaa”, “bbb”, “ccc”, and . . . . That is, in the media table MT, there is stored a media file MF for each of print media usable by the printer 30 having the media table MT. The symbols “aaa”, “bbb”, “ccc”, and . . . are notations for convenience of distinguishing the print media, that is, medium basic information MI described below.

One media file MF corresponds to one type of print media and is information in which the medium basic information MI, image processing information PI, and print setting information SI are associated with each other.

The medium basic information MI includes various types of information relating to the print media such as a name of the print media (media name), a material type of the print media (media type), a provider that provides the print media to the market (media vendor), a size of the print media (length, width, and weight), an updated date and time of the media file MF, and the model name of the printer 30 that can use the print media.

The image processing information PI is information required for the image processing apparatus 20 to generate print data for corresponding print media. For example, the image processing information PI includes a color profile, a color conversion table, a dot distribution table, and the like. The color profile is, for example, an international color consortium (ICC) profile defined in relation to the coloring characteristics of the corresponding print media. The ICC profile is information for reproducing the color tone of an image on the corresponding print media with high accuracy in color conversion processing of a print data generation step, and has practically standardized objectivity in the image processing field.

The color conversion table is a lookup table (LUT) used for conversion of a coloration system of an image (for example, color conversion from RGB (red, green, and blue) coloration system to CMYK coloration system) and is defined corresponding to the characteristics of the corresponding print media. The dot distribution table is a table for dot distribution processing that further distributes raster data for each ink color (for example, CMYK) used by the printer 30 obtained by color conversion processing for printing to any one of a plurality of sizes of dots for each pixel. For example, in a case where the printer 30 is an ink jet printer capable of ejecting three types of dots (large dot, middle dot, small dot) having different ink weight per one drop, in the raster data for each ink color, a gradation value of each pixel is converted into on information or off information of any dot of such three types.

Further, as a detail description of the image processing information PI, the image processing information PI has information for each print mode that the user can arbitrarily select.

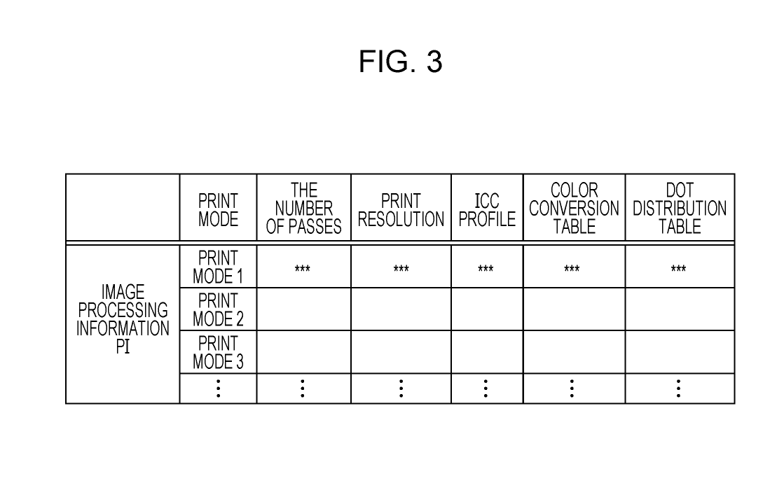

FIG. 3 exemplifies image processing information PI corresponding to one type of print media (for example, print media in which medium basic information MI is “aaa”) and a structure in which information is divided for each print mode. In a case of printing using the print media, it is assumed that the user can select any one of a plurality of print modes 1, 2, 3, and . . . .

Different print modes result in different time required for printing and image quality. As exemplified in FIG. 3, in the image processing information PI, appropriate number of passes, a print resolution, the ICC profile, the color conversion table, the dot distribution table are defined respectively for each print mode 1, 2, 3, and . . . . The number of passes is the number of times that the print head mounted on the carriage of the printer 30 moves over a certain region to print the region of the print media. As the number of passes increases, basically, time required for printing increases, but image quality is improved. The required ICC profile, color conversion table, dot distribution table, and the like are, basically, different for each print mode, but are common in some print modes in some cases.

The print setting information SI is information required for the printer 30 to print on corresponding print media. For example, the print setting information SI includes various setting values for each item such as temperature of the heater, parameter relating to transportation of the print media, drying time of the print media, platen gap which is height from a platen supporting the print media to the print head, cleaning frequency of a nozzle of the print head.

The media server 60 stores a media list 65 (FIG. 1) in which a unique media file MF is registered for each of various types of print media distributed in the market in the storage 62. That is, the media server 60 (storage 62) stores medium print information (media file MF for each of print media) which is information associating the image processing information PI required to generate the print data for each of print media with the print setting information SI required for printing on each of print media. For example, the media file MF for each of print media is generated by a media vendor of each of the print media, is uploaded to the media server 60 through the internet communication network 50, and registered in the media list 65. When the media vendor provides information on print media of the company to an operator (media server administrator) who manages and operates the media server 60, a media file MF generated by the media server administrator based on the provided information may be registered in the media list 65.

A provider that provides a printer to the market (printer vendor) may be included as the media vendor. The media vendor and the printer vendor may be the media server administrator. The media servers 60 may exist corresponding to the number of such media server administrators.

In the media server 60, there is a case where a media file MF once loaded on the media list 65 is updated later. For example, there is a case of performing a specification change of print media or improvement of various types of information (image processing information PI and print setting information SI) for enhancing print quality on print media. With an update of the firmware FW of the printer 30, it may be necessary to update the media file MF of each of print media usable in the printer 30. In the media server 60, when the media file MF is updated, this updated date and time are reflected in the updated date and time described above in the medium basic information MI of the media file MF.

FIG. 2B exemplifies a configuration of a media table MT different from FIG. 2A. The media table MT of FIG. 2B is different from the media table MT of FIG. 2A in that the media table MT of FIG. 2B has an address information AD instead of the image processing information PI. The address information AD is a location information (for example, information referred to as uniform resource identifier (URI) or uniform resource locator (URL)) of the image processing information PI in the storage 62 of the media server 60. That is, the media table MT of FIG. 2B is a collection of the media files MF′ for each of print media in which the medium basic information MI, the address information AD, and the print setting information SI are associated with each other.

The image processing information PI includes a plurality of tables such as the color profile and the color conversion table as described above, and the plurality of tables may exist for each print mode. Therefore, a data amount of the image processing information PI is enormous. Accordingly, it can be said that a data amount of the media file MF′ (refer to FIG. 2B) having the address information AD instead of the image processing information PI is significantly reduced compared with the media file MF (refer to FIG. 2A) having the image processing information PI.

In the printer 30, the processor 31 executes the print management program 37 to access the media server 60 through the communication IF 35 and downloads a media file MF or a the media file MF′ corresponding to print media usable by the apparatus from the media list 65. Thereby, the media file MF or the media file MF′ is stored in the media table MT of the storage 32. Any one of the media file MF or the media file MF′ is stored in the media table MT of one printer 30, and basically there is no mixture of the media file MF and the media file MF′ in the media table MT of one printer 30.

### 3. Download of Media File (MF or MF′)

The processor 31 (print management program 37) causes the display 33 to display a download screen 170 for downloading a media file as triggered by a predetermined operation on the operation panel (display 33 and operation acceptor 34) by the user. A terminal such as a tablet type terminal or a smartphone is connected to the printer 30 by wired or wireless connection, and a display and an input unit (for example, touch panel) of the terminal may function as the display 33 and the operation acceptor 34.

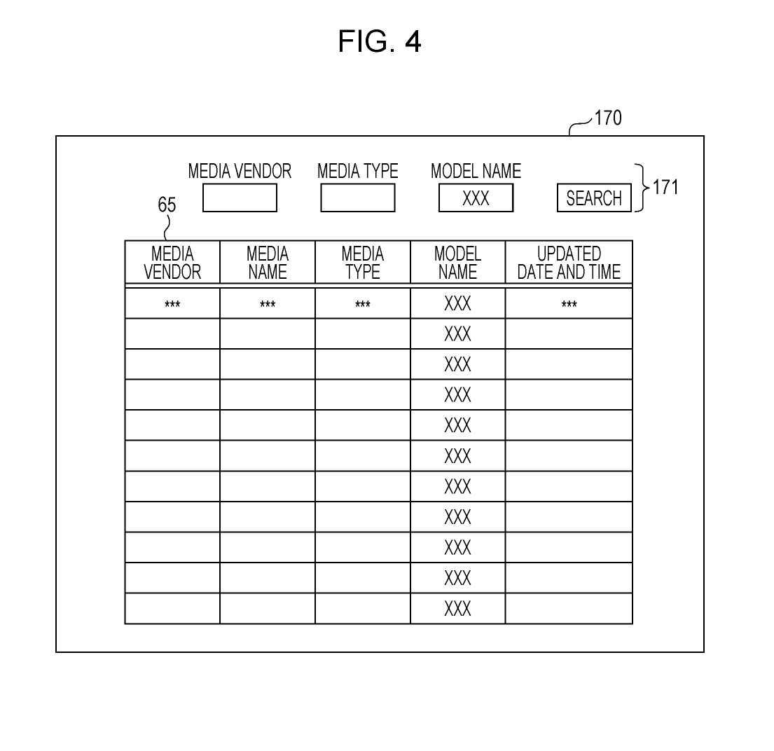

FIG. 4 exemplifies the download screen 170. The download screen 170 is a web page provided by the processor 31. The media list 65 of the media server 60 is displayed on the download screen 170. The media list 65 indicates the existence of the media file MF of the media server 60 with some items included in the medium basic information MI, for example, a media vendor, a media name, a media type, a model name (model name of a printer that can use print media corresponding to the media file MF), and an updated date and time.

For example, the user performs a predetermined operation of arbitrarily selecting and downloading a media file MF from the media list 65 displayed on the download screen 170. At the time, since it is necessary to select a media file MF of print media usable by the printer 30 currently being operated, the user selects a media file MF in which a model name described in the media list 65 matches a model name of the printer 30. When the operation of the user is received, the processor 31 designates the selected media file MF and issues a download request to the media server 60. The processor 31 includes model information of the apparatus (printer 30) in the download request. The model information of the printer 30 includes, for example, storage capability information indicating whether a model has storage capacity equal to or larger than a predetermined capacity. For example, when there is a printer 30 with a specification having storage capacity equal to or larger than the predetermined capacity by the storage 32, the model information includes first storage capability information indicating that the model has the storage capacity equal to or larger than the predetermined capacity. On the other hand, when there is a printer 30 with a specification having storage capacity less than the predetermined capacity by the storage 32, the model information includes second storage capability information indicating that the model does not have the storage capacity equal to or larger than the predetermined capacity.

The processor 61 of the media server 60 that receives the download request from the printer 30 through the communication IF 63 transmits a media file MF designated in the download request or a media file MF′ as an alternative to the media file MF among media files MF registered in the media list 65 (stored in the storage 62) to the printer 30.

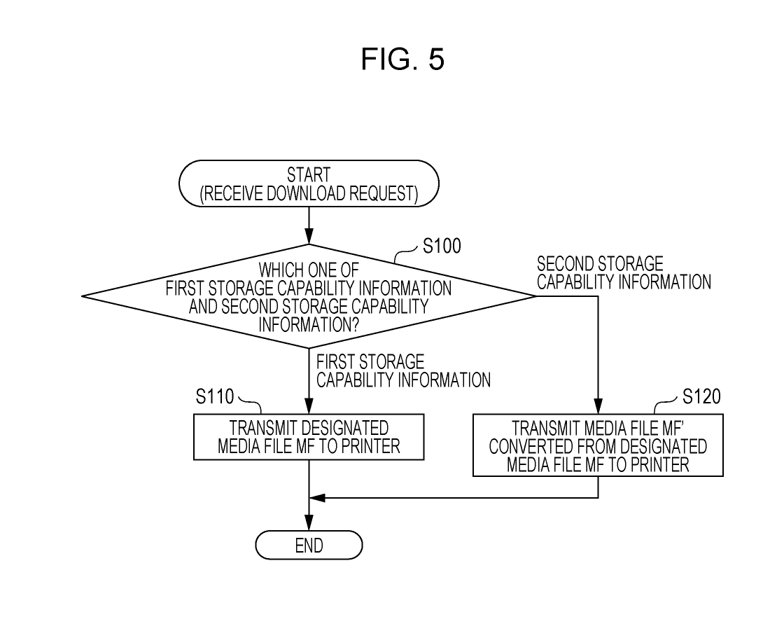

FIG. 5 is a flowchart showing download switching processing executed by the processor 61 of the media server 60 that receives the download request from the printer 30 according to the medium print information providing program 64.

The processor 61 determines whether the model information included in the download request has any one of the first storage capability information or the second storage capability information as triggered by the reception of the download request (step S100). When the model information has the first storage capability information, the processing proceeds to step S110, and when the model information has the second storage capability information, the processing proceeds to step S120.

In step S110, the processor 61 transmits the media file MF designated in the download request to the printer 30 which is a transmission source of the download request.

On the other hand, in step S120, the processor 61 converts the media file MF designated in the download request into a media file MF′ and transmits the converted media file MF′ to the printer 30 which is the transmission source of the download request.

The conversion of the media file MF into the media file MF′ refers to processing of generating a file (media file MF′) in which the image processing information PI is replaced with the address information AD among the image processing information PI of the medium basic information MI, the image processing information PI, and the print setting information SI configuring the media file MF. The processor 61 leaves the media file MF itself before the conversion in the storage 62. According to such configuration, it can be said that the processor 61 switches which of the image processing information PI and the address information AD of the image processing information PI stored in the medium print information storage (storage 62) is to be transmitted to the printer 30 corresponding to the model information acquired from the printer 30.

When the download screen 170 is generated, the processor 31 may request the media server 60 for data for displaying only media file MF corresponding to a model name (for example, model name “xxx”) of the apparatus (printer 30) among the media files MF of the media server 60. In response to the request, the media server 60 transmits the data for displaying only media file MF corresponding to the model name “xxx” among a large number of media files MF to be held to the processor 31. The processor 31 displays a list (a part of media list 65) listing only a media file MF corresponding to the model name “xxx” among the media files MF of the media server 60 on the download screen 170 based on the acquired data (refer to FIG. 4). As a result, a media file MF can arbitrarily be selected from the media list 65 displayed on the download screen 170, so that the user can easily and reliably download a media file MF (or media file MF′) corresponding to the print media usable by the printer 30 (model name “xxx”) being operated.

Further, a search tool 171 for searching a desired media file MF from the media list 65 may be displayed on the download screen 170. According to a search condition (for example, media vendor, media type, and model name) input by the user, the search tool 171 acquires data for displaying only media file MF corresponding to the condition from the media server 60. Based on the acquired data, the processor 31 displays a list (a part of media list 65) listing only a media file MF corresponding to the search condition input into the search tool 171 among the media files MF of the media server 60 on the download screen 170. As a result, a media file MF can arbitrarily be selected from the media list 65 displayed on the download screen 170, so that the user can easily download a media file MF (or media file MF′) corresponding to a desired condition.

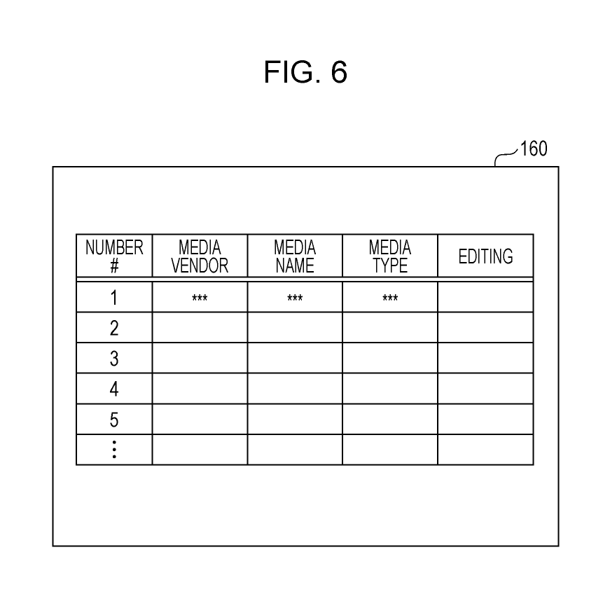

FIG. 6 exemplifies a media registration list 160 displayed on the display 33 by the processor 31. The media registration list 160 indicates the existence of the media file MF (or media file MF′) downloaded from the media server 60 to the printer 30 as described above. In the example of FIG. 6, the media registration list 160 indicates the existence of each downloaded media file MF (or media file MF′) to the user with some items included in the medium basic information MI, for example, a media vendor, a media name, a media type.

In the media registration list 160, a media file MF (or media file MF′) is registered in association with a media number. The media number is, for example, a series number starting from #1 and a number for convenience to identify print media only in the system 1 including the printer 30 for each printer 30. The media number is not downloaded from the media server 60 as the medium basic information MI. The user arbitrarily selects a media number (for example, media number #1) from the media registration list 160 at a predetermined timing (for example, timing before selecting a media file MF on the download screen 170). In addition, a media file MF (or media file MF′) is downloaded from the media server 60 by operating the download screen 170 as described above. The processor 31 displays a description of the downloaded media file MF (or media file MF′) in a field corresponding to a media number selected in the media registration list 160. The processor 31 stores the downloaded media file MF (or media file MF′) in the storage 32 (as a part of media table MT) in association with the selected media number.

As described above, each media file MF (or the media file MF′) stored in the storage 32 corresponds to a specific content example of the media table MT (FIG. 2A or FIG. 2B). In a case of downloading a media file MF′ from the media server 60, it can be said that the processor 31 functions as a storage processor that is configured to acquire the print setting information SI and the address information AD in the storage 62 (first storage) of the image processing information PI from the media server 60 and store the acquired pieces of information in the storage 32 (second storage) in association with print media.

The processor 31 may periodically check by communicating with the media server 60 that the media file MF for each of print media usable by the printer 30 is registered or updated newly in the media list 65 of the media server 60 and, according to the check result, may automatically download a media file MF (or the media file MF′) not yet downloaded from the media server 60.

### 4. Editing of Print Setting Information SI

The user can edit print setting information SI of a media file MF (or the media file MF′) registered in the media registration list 160. In a state where a media file MF (or the media file MF′) to be edited of the print setting information SI is selected in the media registration list 160, the user performs a predetermined operation for starting the editing. In response to the operation, the processor 31 displays an editing screen 180 for editing the print setting information SI of the editing target file MF (or the media file MF′) on the display 33.

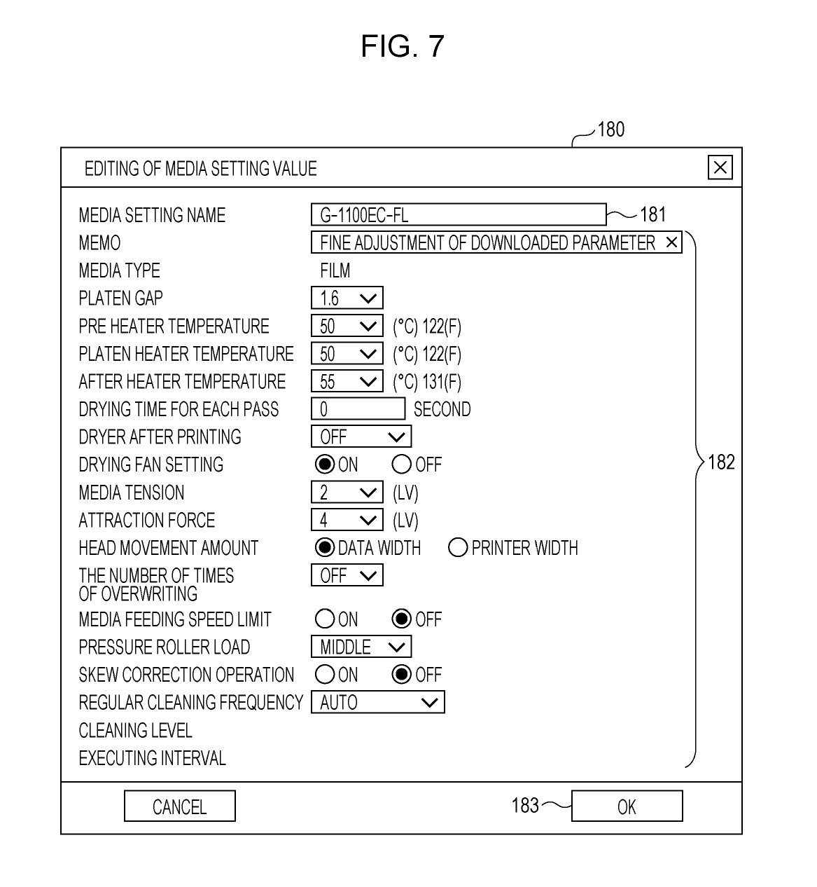

FIG. 7 exemplifies the editing screen 180. The editing screen 180 has an editing input field 181 capable of editing a part of medium basic information MI of the editing target file MF (or the media file MF′) such as a media name (media setting name) and has an editing input field 182 capable of mainly editing each item of the print setting information SI. The user performs arbitrary input into the editing input field 182, so that a setting value of each item (for example, platen gap, heater temperature, parameter relating to transportation of print media, drying time of print media, cleaning frequency) of current print setting information SI of the editing target file MF (or the media file MF′) can be changed (edited).

The user performs the arbitrary input into the editing input field 182 and then operates an OK button 183 prepared on the editing screen 180. In response to the operation of the OK button 183, the processor 31 ends the display of the editing screen 180 and updates the print setting information SI or the like of the editing target media file MF (or the media file MF′) stored in the storage 32 based on editing content in the editing screen 180. Thereby, the print setting information SI of a media file MF (or the media file MF′) arbitrarily selected by the user as the editing target in the media registration list 160 is edited.

### 5. Print Data Generation Processing by Image Processing Apparatus 20

Next, an operation of the image processing apparatus 20 in the system 1 will be described.

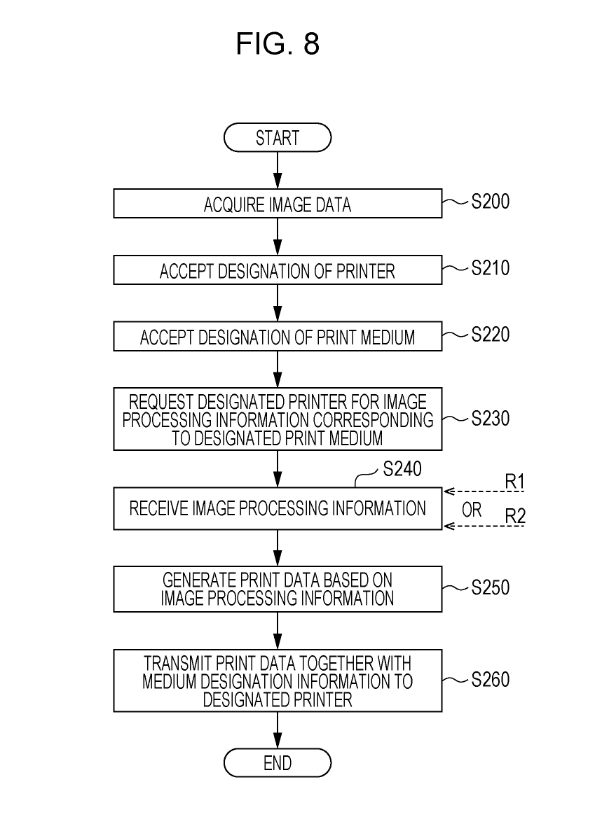

FIG. 8 is a flowchart showing print data generation processing realized by causing the processor 21 of the image processing apparatus 20 to execute the image processing program 26.

The processor 21 acquires image data showing an image to be printed in response to an operation of the user (step S200). Here, the image data is, for example, image data generated by document creation software and drawing software mounted in the image processing apparatus 20 and image data input from an external digital camera or scanner, another PC, or the like.

The processor 21 accepts the designation of a printer 30 for executing print processing (step S210). Here, for example, it is assumed that the processor 21 already recognizes each printer 30 that can be designated as the printer 30 for executing print processing based on a previous communication with each printer 30 included in the system 1 through the LAN 40. The processor 21 generates a user interface (UI) screen (print condition input UI screen) for inputting the designation of the printer 30 and displays the generated screen on the display 23. In the print condition input UI screen, each printer 30 included in the system 1 is displayed in a manner that allows the user to identify each printer based on printer identification information. The printer identification information includes, for example, a model name of a printer 30, an IP address, a serial number, and version information of firmware FW. Accordingly, the user can know the printer 30 that can be designated by viewing the print condition input UI screen and operates the operation acceptor 24 to perform input for designating a printer 30 on the print condition input UI screen. The processor 21 accepts such designation.

Next, The processor 21 accepts the designation of a print medium to be used for printing (step S220). The processor 21 inquires the usable print media to the printer (hereinafter, designated printer) 30 according to the designation accepted in step S210 through the communication IF 25. The processor 31 of the designated printer 30 that receives the inquiry from the image processing apparatus 20 transmits medium basic information MI of each media file MF (or the media file MF′) stored in the media table MT of the storage 32 to the image processing apparatus 20 which is a transmission source of the inquiry through the communication IF 35. At the time, the processor 31 may transmit a media number associated with each media file MF (or the media file MF′) in the media table MT to the image processing apparatus 20 in addition to the medium basic information MI of each media file MF (or the media file MF′). Hereinafter, the medium basic information MI and the media number relating to the print media are referred to collectively as the medium basic information MI or the like.

The processor 21 generates the UI screen (a type of the print condition input UI screen) for inputting the designation of the print medium based on medium basic information MI or the like of each media file MF (or the media file MF′) transmitted from the designated printer 30 as described above and displays the generated screen on the display 23. As a result, the print condition input UI screen displays information (for example, media name, media type, media vendor, and media number) of each of print media usable in the designated printer 30. Accordingly, the user can know the print media that can be designated in the designated printer 30 by viewing the print condition input UI screen and operates the operation acceptor 24 to perform input for designating the print medium on the print condition input UI screen. The processor 21 accepts such designation.

The image processing apparatus 20 that accepts the designation of the printer 30 and the print medium requests the designated printer 30 for the image processing information PI corresponding to the designated print medium to (step S230). That is, in the embodiment, in a state where the printer 30 has the media file MF or the media file MF′ by storing the media file MF or the media file MF′ corresponding to the print media usable by the apparatus in the media table MT of the storage 32 in advance, the request of the image processing information PI is received from the image processing apparatus 20 (step S230). The request in step S230 is realized by, for example, a hypertext transfer protocol (HTTP) request. In the case, the image processing apparatus 20 includes address information of the image processing apparatus 20 itself which is the request source and medium designation information designating the print medium in the request and transmits the request including the pieces of information to the designated printer 30 through the communication IF 25.

In steps S210 and S220, it is assumed that the user designates a printer 30 having a model name “xxx” and designates a print medium assigned a media number #1 among a plurality of print media usable by the printer 30 having the model name “xxx” through the print condition input UI screen. In the case, the image processing apparatus 20 transmits the medium designation information (=the media number #1) to the designated printer 30 (printer 30 having model name “xxx”). Assuming that a plurality of printers 30 of the same model are included in the plurality of printers 30 included in the system 1, the image processing apparatus 20 may identify the designated printer 30 by, for example, a combination of model name and IP address or serial number.

Here, processing of the printer 30 (designated printer 30) side that receives the request in step S230 from the image processing apparatus 20 will be described. The processor 31 of the designated printer 30 reads the image processing information PI or the address information AD from the media file MF or the media file MF′ stored in the media table MT of the storage 32 corresponding to the print medium indicated by the received medium designation information together with the request. That is, when the media table MT of the designated printer 30 stores the media file MF for each of print media, the processor 31 of the designated printer 30 reads the image processing information PI corresponding to the print medium indicated by the medium designation information received from the image processing apparatus 20 from the media table MT. In a case where the image processing information PI is read from the media table MT, the processor 31 of the designated printer 30 transmits the read image processing information PI to the image processing apparatus 20 which is the transmission source of the request in step S230 through the communication IF 35 (response R1).

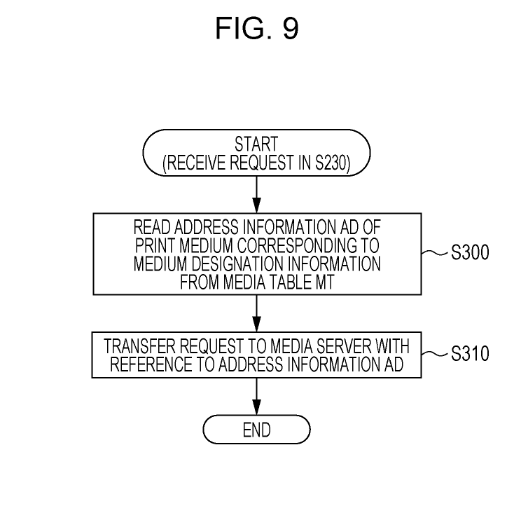

On the other hand, when the media table MT of the designated printer 30 stores the media file MF′ for each of print media, the processor 31 of the designated printer 30 reads the address information AD corresponding to the print medium indicated by the medium designation information received from the image processing apparatus 20 from the media table MT (step S300 in FIG. 9).

FIG. 9 is a flowchart showing processing executed in a case where the processor 31 (print management program 37) of the designated printer 30 having the media table MT that stores the media file MF′ receives a request in step S230 from the image processing apparatus 20. The processor 31 that reads the address information AD from the media table MT transfers the request to the media server 60 with reference to the address information AD (step S310). It can be said that the processor 31 executing the steps S300 and S310 functions as a transfer processor. Specifically, the processor 31 transfers the request from the image processing apparatus 20 to the media server 60 and instructs the media server 60 to transfer the image processing information PI stored at a location in the storage 62 indicated by the read address information AD to the image processing apparatus 20 which is the transmission source of the request. That is, in a case where the request of the image processing information PI is received from the image processing apparatus 20, the processor 31 (transfer processor) executing the steps S300 and S310 transfers the request to the media server 60 with reference to the address information AD stored in the storage 32 corresponding to the medium designation information, so that the image processing apparatus 20 acquires the image processing information PI from the media server 60.

The processor 61 (medium print information providing program 64) of the media server 60 that receives the transfer of such request reads the image processing information PI from the storage 62 based on the referred address information AD and transmits the read image processing information PI to the image processing apparatus 20 which is the transmission source of the request (response R2).

As a result of executing the request in step S230, the processor 21 of the image processing apparatus 20 receives any one of the response R1 from the designated printer 30 or the response R2 from the media server 60. The processor 21 receives the image processing information PI corresponding to the designated print medium regardless of receiving any one of the response R1 or the response R2 (step S240). Thereby, the image processing apparatus 20 acquires the image processing information PI necessary for generating print data corresponding to the designated print medium. A series of processing in which the image processing information PI is transmitted as the response R2 from the media server 60 to the image processing apparatus 20 that transmits the request in step S230 to the designated printer 30 can be expressed as the transmission of the image processing information PI by redirect.

Next, the processor 21 generates print data for the designated print medium based on the received image processing information PI (step S250). In the case, image processing based on the image processing information PI is executed with respect to the acquired image data in order to generate raster data (print data) for each ink color (for example, CMYK) used by the designated printer 30 for printing. For example, the processor 21 executes resolution conversion processing corresponding to a print resolution included in the image processing information PI, color conversion processing using a color conversion table, color matching using a color profile, dot distribution processing using a dot distribution table, and data rearranging processing corresponding to the number of passes with respect to the image data and finally generates print data in a form to be provided to the printer 30.

As described above, in some cases, the image processing information PI has information for each print mode (FIG. 3). In a case where the image processing information PI has the information for each print mode, the processor 21 displays a UI screen for designating any one of such print modes on the display 23 and accepts the designation of the print mode by an operation of the operation acceptor 24 of the user. Then, the processor 21 generates the print data based on the image processing information PI such as the number of passes, a print resolution, a color profile, a color conversion table, a dot distribution table corresponding to the designated print mode. That is, print data optimum for a combination of a printer 30, print media, and a print mode arbitrarily designated by the user is generated.

The processor 21 transmits the generated print data together with the medium designation information designating a print medium to the designated printer 30 through communication IF 25 (step S260). Needless to say, the medium designation information transmitted together with the print data in step S260 is information (here, media number) indicating the print medium according to the designation accepted in step S220, and the printer 30 which is a transmission destination in step S260 is a printer 30 according to the designation accepted in step S210. The transmission of the medium designation information together with the print data includes a mode of transmitting the medium designation information by attaching or linking to the print data, a mode of transmitting the medium designation information included in the print data, and the like. In a case where the designation of the print mode is received as described above at the time of generating the print data, the processor 21 transmits the print data including the print mode designation information for designating the designated print mode, that is, the print mode to be employed for printing to the printer 30 in step S260. The print mode designation information is information including specific content of a print mode such as the number of passes.

### 6. Print Processing by Printer 30

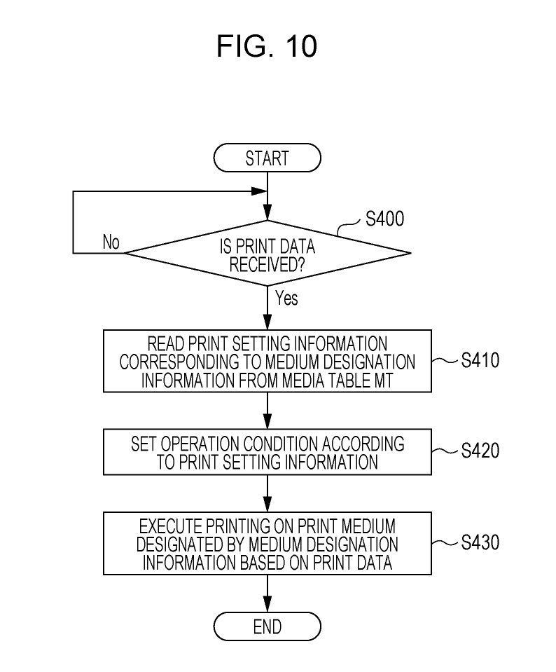

FIG. 10 is a flowchart showing print processing executed by the processor 31 of the printer 30 according to firmware FW.

The processor 31 determines whether print data is received from the outside through the communication IF 35 (step S400). In a case of receiving the print data (“Yes” in step S400), the processing proceeds to step S410. The printer 30 (designated printer 30) receives the print data generated for the print medium designated by the medium designation information and the medium designation information transmitted from the image processing apparatus 20 as described above.

In step S410, the processor 31 acquires the received medium designation information together with the print data and reads print setting information SI corresponding to the medium designation information (media number) from the media table MT of the storage 32. Since the medium designation information is transmitted together with the print data (included in the print data) as described above from the image processing apparatus 20 to the printer 30, the print medium designated by such medium designation information can also be expressed as the print medium designated by the print data.

Next, the processor 31 sets an operation condition of each portion of the printer engine 36 according to the print setting information SI read in step S410 (step S420). According to the read print setting information SI, the processor 31 sets various items such as heater temperature, transportation of print media by transport mechanism, drying time of print media, platen gap, and cleaning frequency. Then, the processor 31 transfers the received print data to the printer engine 36 and causes the printer engine 36 to execute printing based on the print data to the print medium designated by the received medium designation information (step S430). That is, the processor 31 and the printer engine 36 cooperate to function as a print processor for executing the printing based on the print data with a setting according to the print setting information SI.

In some cases, the processor 31 receives print data including the print mode designation information from the image processing apparatus 20. In the case where the print data including the print mode designation information is received, the processor 31 causes the printer engine 36 to execute printing according to the print mode designated by the print mode designation information. For example, in response to the number of passes of the print mode indicated by the print mode designation information, the processor 31 can control an operation of the carriage of the printer engine 36 and a transportation timing of the transport mechanism. The printing on the print medium designated by the user by the printer 30 designated by the user is completed.

### 7. Summary

As described above, in the embodiment, the printer 30 stores the media table MT that stores any one of the media file MF associating the image processing information PI required to generate the print data for the print media with the print setting information SI required for printing on the print media or the media file MF′ associating the address information AD in the media server 60 of the image processing information PI with the print setting information SI in the storage 32. As a result of requesting the image processing information PI corresponding to the designated print medium to the printer 30, the image processing apparatus 20 acquires the image processing information PI from the printer 30 or the media server 60. Then, the image processing apparatus 20 generates the print data for the designated print medium based on the acquired image processing information PI and transmits the medium designation information and the generated print data to the printer 30. The printer 30 receives the medium designation information and the print data generated by the image processing apparatus 20. Then, the print setting information SI corresponding to the print medium designated by the received medium designation information is read from the media table MT of the storage 32, and the printing of the received print data is executed with a setting according to the read print setting information SI.

That is, the image processing apparatus 20 generates the print data based on the image processing information PI corresponding to the print medium designated by the medium designation information, and the printer 30 performs the printing based on the print data by employing the setting according to the print setting information SI corresponding to the print medium designated by the medium designation information. Accordingly, inconsistency (mismatch in corresponding print media) does not occur between the image processing information PI used when the image processing apparatus 20 generates the print data and the print setting information SI used when the printer 30 performs the printing based on the print data, and a printed object with high quality can be obtained. In particular, the embodiment has a significant effect when print data with precise color matching according to characteristics of print media by color matching or the like using the ICC profile in the RIP apparatus (image processing apparatus 20) is generated, a fine print setting (for example, heater temperature and platen gap) corresponding to the print media in the LFP (printer 30) is performed, and then the printed object with high quality is printed based on the print data. When the print media targeted at the time of generating the print data is different from the print media targeted at the time of the print setting by the printer 30, the print data and the print setting do not become an optimum combination, as a result, the printed object with high quality expected by the user cannot be obtained. However, according to the embodiment, since the mismatch of the print media is prevented surely as described above, it is possible to obtain the printed object with high quality expected by the user.

According to the embodiment, in a case where the request of the image processing information PI corresponding to the designated print medium is received from the image processing apparatus 20, the printer 30 that acquires the media file MF′ associating the address information AD with the print setting information SI in the media server 60 of the image processing information PI from the media server 60 and stores the media file MF′ in the storage 32 transfers the request to the media server 60 with reference to the address information AD stored in the storage 32 corresponding to the designated print medium. Then, the media server 60 that receives the transfer of the request reads the image processing information PI from the storage 62 based on the referred address information AD and transmits the read image processing information PI to the image processing apparatus 20. That is, even when the printer 30 holds the address information AD instead of the image processing information PI, it is possible for the image processing apparatus 20 to acquire the image processing information PI required by the image processing apparatus 20.

In particular, even when there is a product (product having the second storage capability information as model information) with a specification not having storage capacity for storing the image processing information PI having a large data amount, the printer 30 can cause the image processing apparatus 20 to acquire the image processing information PI by holding the address information AD instead of the image processing information PI as described above.

### 8. Another Embodiment

The model information of the printer 30 to be referred to when the media server 60 switches which of the image processing information PI and the address information AD in the storage 62 of the image processing information PI is to be transmitted to the printer 30 is not limited to the information on the storage capacity of the printer 30 as described above. For example, the model information of the printer 30 includes information indicating a processing capability relating on communication of the printer 30. Corresponding to the model information of the printer 30, in a case where it is recognized that the printer 30 has a communication processing capability equal to or larger than a predetermined communication processing capability, the media server 60 may proceed the processing to step S110 in the processing of FIG. 5. In a case where it is not recognized that the printer 30 has a communication processing capability equal to or larger than a predetermined communication processing capability, the media server 60 may proceed the processing to step S120.

Alternatively, more simply, based on the model name or the like of the printer 30, the media server 60 may switch which of the image processing information PI and the address information AD in the storage 62 of the image processing information PI is to be transmitted to the printer 30. It is assumed that the media server 60 separately stores model names of various printers 30 in advance into a product group (first product group) that can endure reception and storage of the image processing information PI and a product group (second product group) that cannot endure reception and storage thereof. In a case where a model name (a type of model information) acquired from the printer 30 belongs to the first product group, the media server 60 may proceed the processing to step S110 in the processing of FIG. 5. In a case where a model name acquired from the printer 30 belongs to the second product group, the media server 60 may proceed the processing to step S120.

In an embodiment, browsing and input executable by the user through the operation panel (display 33 and the operation acceptor 34) of the printer 30 may be executable using a terminal such as an external PC. Here, the external terminal refers to, for example, the image processing apparatus 20 or a PC other than the image processing apparatus 20. That is, it is assumed that the external terminal has already installed application software capable of displaying various UI screens such as the media registration list 160, the download screen 170, and the editing screen 180 generated and provided by the printer 30 based on the communication with the printer 30. The external terminal may display the UI screens on a predetermined display using a function of the application software to allow the user the browsing and the input.

The media server 60 may be a local server provided in a local network (LAN 40), not a server accessible through the internet communication network 50. When the media server 60 is the local server, it is possible to strengthen security (leakage countermeasure) on information held by the media server 60.

The image processing program 26 mounted in the image processing apparatus 20 is the RIP software and may function as a printer driver for generating the print data and controlling the printer 30 to execute the printing based on the print data.

The functions realized by software described so far may be realized by hardware.

What is claimed is:

1. A print processing system comprising:
a server that includes a first storage that stores image processing information used for generating print data for each of print media; and
a print apparatus that executes printing based on the print data,
wherein the print apparatus includes a second storage that stores access information for accessing the image processing information stored in the first storage and a transfer processor that is configured to transfer a request to the server with reference to the access information stored in the second storage corresponding to a designated print medium in a case where the request of the image processing information corresponding to the designated print medium is received from an image processing apparatus generating the print data, and
wherein in a case of receiving the request, the server reads the image processing information from the first storage based on the referred access information and transmits the read image processing information to the image processing apparatus.

2. The print processing system according to claim 1,
wherein the server stores medium print information which is information associating the image processing information with print setting information required for printing on each of print media in the first storage, and
wherein the print apparatus includes a storage processor that is configured to acquire the print setting information and the access information from the first storage and store the acquired pieces of information in the second storage in association with the print media.

3. The print processing system according to claim 2,
wherein the server switches which of the image processing information stored in the first storage and the access information of the image processing information in the first storage is to be transmitted to the print apparatus based on model information of the print apparatus acquired from the print apparatus.

4. The print processing system according to claim 3,
wherein the storage processor stores any one of the print setting information and the image processing information or the print setting information and the access information transmitted from the server in the second storage.

5. The print processing system according to claim 4,
wherein the server transmits the print setting information and the image processing information to the print apparatus in a case where the model information indicates that a model has storage capacity equal to or larger than a predetermined capacity, and transmits the print setting information and the access information to the print apparatus in a case where the model information does not indicate that a model has storage capacity equal to or larger than the predetermined capacity.

6. A server that communicates with a print apparatus, the server comprising:
a storage that stores image processing information required to generate print data for each of print media; and
a communication processor that is configured to control the communication,
wherein the communication processor switches which of the image processing information stored in the storage and access information of the image processing information in the storage is to be transmitted to the print apparatus based on model information of the print apparatus acquired from the print apparatus.

7. The server according to claim 6,
wherein the communication processor transmits the image processing information to the print apparatus in a case where the model information indicates that a model has storage capacity equal to or larger than a predetermined capacity, and transmits the access information to the print apparatus in a case where the model information does not indicate that a model has storage capacity equal to or larger than the predetermined capacity.

8. A print apparatus comprising:
a storage that stores access information of image processing information used for generating print data for each of print media; and
a transfer processor that is configured to transfer a request to a server to acquire image processing information from the server with reference to the access information stored in the storage corresponding to a designated print medium in a case where the request of the image processing information corresponding to the designated print medium is received from an image processing apparatus generating the print data.
